(19) United States
(12) Patent Application Publication
(10) Pub. No.: US 2015/0226378 A1
(43) Pub. Date: Aug. 13, 2015

(54) LIQUEFIED GAS FUEL FILLING SYSTEM

(71) Applicants: ISUZU MOTORS LIMITED, Tokyo (JP); MIYAIRI VALVE MFG. CO., LTD., Tokyo (JP)

(72) Inventors: Shigehisa Takase, Machida-shi (JP); Kenichi Shintani, Yokohama-shi (JP); Norio Fujii, Nerima-ku (JP); Hiroyuki Amemori, Kawasaki-shi (JP)

(21) Appl. No.: 14/426,632

(22) PCT Filed: Aug. 29, 2013
(86) PCT No.: PCT/JP2013/073101

§ 371 Date: Mar. 6, 2015

(30) Foreign Application Priority Data
Sep. 7, 2012 (JP) 2012-197666

(51) Int. Cl. F17C 5/02

(52) U.S. Cl. CPC F17C 5/02; F17C 2221/01; F17C 2223/033; F17C 2223/046; F17C 2223/0153; F17C 2225/046; F17C 2225/033; F17C 2225/0153; F17C 2260/02; F17C 2265/065; F17C 2270/0171

(57) ABSTRACT

A liquefied gas fuel filling system provided with a filling and pressure-balanced receptacle at a vehicle side combined with a filling and pressure-balanced nozzle at a station side connected with a storage tank, and an excess flow prevention valve provided in a pressure-balanced line for making the filling and pressure-balanced receptacle and a gas-phase region of a fuel tank contact each other. An orifice is provided in a pressure-balanced receptacle of the filling and pressure-balanced receptacle, thereby enabling the fuel tank to be smoothly filled with liquefied gas even when the outside air temperature rises.

### TECHNICAL FIELD

The present invention relates to a liquefied gas fuel filling system and, more particularly, to a liquefied gas fuel filling system in which liquefied gas can be smoothly filled into a fuel tank of a vehicle even when an outside air temperature rises.

### BACKGROUND ART

As a countermeasure of air pollution caused by exhaust gas from diesel engine, it is discussed to use liquefied gas such as dimethyl ether (DME), in place of light oil that is conventional fuel (e.g. refer to Japanese patent application Kokai publication No. 2010-255686). When the liquefied gas is filled from a storage tank of a filling stand into a fuel tank of a vehicle, a, so-called, pressurized-filling method for pressing the liquefied gas at a filling stand side was adopted.

However, the above-descried pressurized-filling method had a problem in which a large vehicle having a large fuel tank capacity such as a truck has a slow filling speed and thus needs a long filling time when a differential pressure between a filling pressure at the filling stand and an inner pressure of the fuel tank is low.

Then, a, so-called, pressure-balanced filling method is adopted in which the liquefied gas is filled from the storage tank into the fuel tank while a gas-phase region of the storage tank at the filling stand and that of the fuel tank contact with each other via pipe to equalize the inner pressure of the storage tank and that of the fuel tank (e.g. refer to Japanese patent application Kokai publication No. 2007-262903).

FIG. 7 illustrates an example of the liquefied gas fuel filling system by the pressure-balanced filling method. In drawings of the system hereinafter, a solid-bold line indicates a liquid-phase line and an outline-bold line indicates a gas-phase line.

In the liquefied gas fuel filling system, a filling and pressure-balanced receptacle 62 at a vehicle side connected with a gas-phase region 61a and a liquid-phase region 61b of the fuel tank 61 supplying the liquefied gas to a diesel engine of the vehicle is combined with a filling and pressure-balanced nozzle 65 at a stand side connected to the gas-phase region 63a and the liquid-phase region 63b of the storage tank 63 at the filling stand side via a pressing device “P” such as a pump and a flowing-amount measuring device 64, so that the gas phases 61a, 63a of the fuel tank 61 and storage tank 63 respectively contact with each other via the pressure-balanced line 66 to equalize pressure, and also the liquid-phase regions 61b, 63b are connected with each other via the filling line 68.

In the fuel tank 61, a pressing and feed pump 69 is provided for sending out the liquefied gas to the diesel engine 60 via a supply pipe 67. Most liquefied gas supplied to the diesel engine 60 is combusted to add a drive force to an engine, however an excess is returned to the fuel tank 61 via a return pipe 70. Further, the pressure-balanced line 66 connecting the gas-phase region 61a of the fuel tank 61 with the filling and pressure-balanced receptacle 62 includes a pressure-balanced pipe 72 provided with a pressure-balanced valve 71. To prevent the liquefied gas from abnormally flowing out when the pressure-balanced pipe 72 is ruptured, an excess flow prevention valve 73 is provided inside the pressure-balanced valve 71.

As illustrated in FIG. 8, the excess flow prevention valve 73 is provided at one end portion of a flowing passage 74 of the pressure-balanced valve 71, and always urged in a direction for opening the flowing passage 74 by a support shaft 75 having an elastic force. As illustrated in FIG. 9, when a rupture 76 is generated on the pressure-balanced pipe 72 to increase a flow amount of the gas flowing from the fuel tank 61 to the pressure-balanced pipe 72 to be an action differential pressure (e.g., 0.2 MPa) or more, the excess flow prevention valve 73 is pressed against the elastic force of the support shaft 75 to close the flowing passage 74.

Therefore, when the fuel is filled in a time such as summer when an outside air temperature is high, compared to the inner pressure of the storage tank 63, the inner pressure of the fuel tank 61 becomes greatly higher. Thus, when the filling is started, right after the filling and pressure-balanced receptacle 62 and the filling and pressure-balanced nozzle 65 are connected with each other to make the gas-phase 61a of the fuel tank 61 and the gas-phase region 63a of the storage tank 63 contact with each other, a great amount of gas may flow to cause the excess flow prevention valve 73 to act from a fuel tank 61 side to a storage tank 63 side in the pressure-balanced pipe 72. When the excess flow prevention valve 73 acts while the fuel is being filled, the pressure-balanced line 66 is closed, which may cause problems for the liquefied gas to be filled.

For example, when the DME is filled from the storage tank 63 to the fuel tank 61 at the outside air temperature is 35 degrees, the temperature of the storage tank 63 becomes almost equal to the outside air temperature. Thus, as illustrated in FIG. 10, the inside pressure (vapor pressure) becomes to be about 0.78 MPa. On the other hand, since a temperature of the fuel tank 61 rises up to 55 degrees due to an impact of the fuel that has received the heat from the diesel engine 60 and has come back via the return pipe 70, or heat radiation on a surface of a road, its inner pressure becomes to be about 1.28 MPa. Therefore, the differential pressure between the fuel tank 61 and the storage tank 63 becomes to be 0.5 MPa, which exceeds the action differential pressure (0.2 MPa) of the excess flow prevention valve 73. Thus, the pressure-balanced line 66 is closed.

Considering cases described above, it is desired to realize the fuel filling system in which the liquefied gas can be smoothly filled from the storage tank 63 into the fuel tank 61 even when the outside air temperature rises.

### PRIOR ART DOCUMENT

### Patent Documents

Patent Document 1: Japanese patent application Kokai publication No. 2010-255686

Patent Document 2: Japanese patent application Kokai publication No. 2007-262903

### SUMMARY OF THE INVENTION

### Problem to be Solved by the Invention

An object of the present invention is to provide a liquefied gas fuel filling system in which the liquefied gas can be smoothly filled into a fuel tank of a vehicle, even when an outside air temperature rises.

### Means for Solving the Problems

A liquefied gas fuel filling system includes a first connection device configured to connect with a gas-phase region and a liquid-phase region of a storage tank of liquefied gas; a second connection device being removable from the first connection device and configured to connect with a gas-phase region and a liquid-phase region of a fuel tank of a vehicle; and an excess flow prevention valve provided at a pressure-balanced line for making the second connection device and the gas-phase region of the fuel tank contact with each other, the gas-phase regions of the storage tank and the fuel tank being connected with each other and the liquid-phase regions thereof being connected with each other so as to fill the liquefied gas from the storage tank into the fuel tank, characterized in that an orifice is provided at a place where the orifice is connected with the pressure-balanced line of the second connection device, or between the second connection device and the excess flow prevention valve in the pressure-balanced line.

In the above-described liquefied gas fuel filling system, the DME is preferably used as the liquefied gas.

### Effect of the Invention

According to the liquefied gas fuel filling system of the present invention, even when a differential pressure between a gas-phase region of a storage tank and that of a fuel tank becomes larger when the outside air temperature becomes higher, a flow amount of gas flowing in a pressure-balanced line is limited with an orifice so that an excess flow prevention valve does not act, and thus the liquefied gas can be smoothly filled from the storage tank into the fuel tank.

### BRIEF DESCRIPTION OF THE DRAWINGS

FIG. 1 is a system view of a liquefied gas fuel filling system according to a first embodiment of the present invention.

FIG. 2 is a system view of the liquefied gas fuel filling system when fuel is filled.

FIG. 3 is a cross-sectional view of a filling receptacle.

FIG. 4 is a system view of the liquefied gas fuel filling system according to a second embodiment of the present invention.

FIG. 5 is a system view of another example of the liquefied gas fuel filling system according to the first embodiment of the present invention.

FIG. 6 is a system view of another example of the liquefied gas fuel filling system according to the second embodiment of the present invention.

FIG. 7 is a system view of a conventional liquefied gas fuel filling system.

FIG. 8 is a cross-sectional view illustrating a configuration of an excess flow prevention valve.

FIG. 9 is a cross-sectional view illustrating a state when the excess flow prevention valve acts.

FIG. 10 is a graph illustrating a relationship between a temperature of DME and a vapor pressure.

### MODES FOR CARRYING OUT THE INVENTION

With reference to drawings, embodiments of the present invention will be described below.

FIG. 1 illustrates a liquefied gas fuel filling system according to a first embodiment of the present invention.

The liquefied gas fuel filling system mainly includes a fuel tank 2 for supplying DME to a diesel engine 1 of a vehicle, a filling and pressure-balanced receptacle 5 at a vehicle side connecting to a gas-phase region 2a and a liquid-phase region 2b of the fuel tank 2 via a pressure-balanced line 3 and a filling line 4, and a filling and pressure-balanced nozzle 8 at a stand side connecting to a gas-phase region 6a and a liquid-phase region 6b of the storage tank 6 at a filling stand via a measuring device 7. The filling and pressure-balanced receptacle 5 and the filling and pressure-balanced nozzle 8 are formed in a pair of removable connection devices, and are combined with each other only when the fuel is filled.

When the vehicle is driven, the DME stored in the fuel tank 2 is suctioned up into a supply pipe 11 via a first electromagnetic valve 10 by a pressing and feed pump 9 provided in the tank, and supplied into a supply pump 13 after a fuel supply pressure is adjusted by a secondary feed pump 12. The excess DME by the secondary feed pump 12 is returned to the fuel tank 2 via a return pipe 15A provided with a first return valve 14.

The DME supplied into the supply pump 13 is pressed up to a predetermined injection pressure (several tens to several hundreds MPa), and then pressed and sent to a common rail 16. The DME is injected into a combustion chamber of each cylinder of diesel engine 1 at a predetermined timing by a plurality of injectors 17. The excess DME in the supply pump 13 is flown into a main return pipe 19 via a return pipe 15B provided with a check valve 18A. Further, the excess DME in the common rail 16 is flown into the main return pipe 19 via two return pipe 15C, 15D provided with the safety valve 18B and a pressure reducing electromagnetic valve 20 respectively. The DME flown into the main return pipe 19 is returned into the fuel tank 2 via a second return valve 21 with the excess DME in the injector 17.

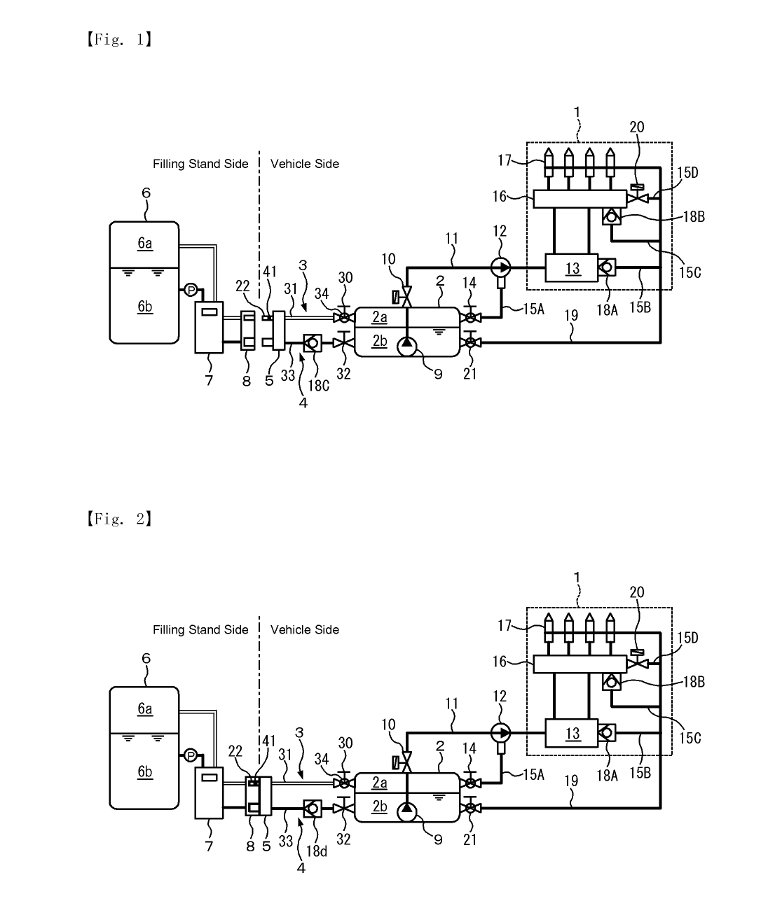

When the fuel is filled, as illustrated in FIG. 2, the filling and pressure-balanced receptacle 5 and the filling and pressure-balanced nozzle 8 are combined with each other so that the gas-phase regions 6a, 2a of the storage tank 6 and the fuel tank 2 respectively contact with each other via the pressure-balanced line 3 to equalize pressure and also the liquid-phase regions 6b, 2b are connected with each other via the filling line 4.

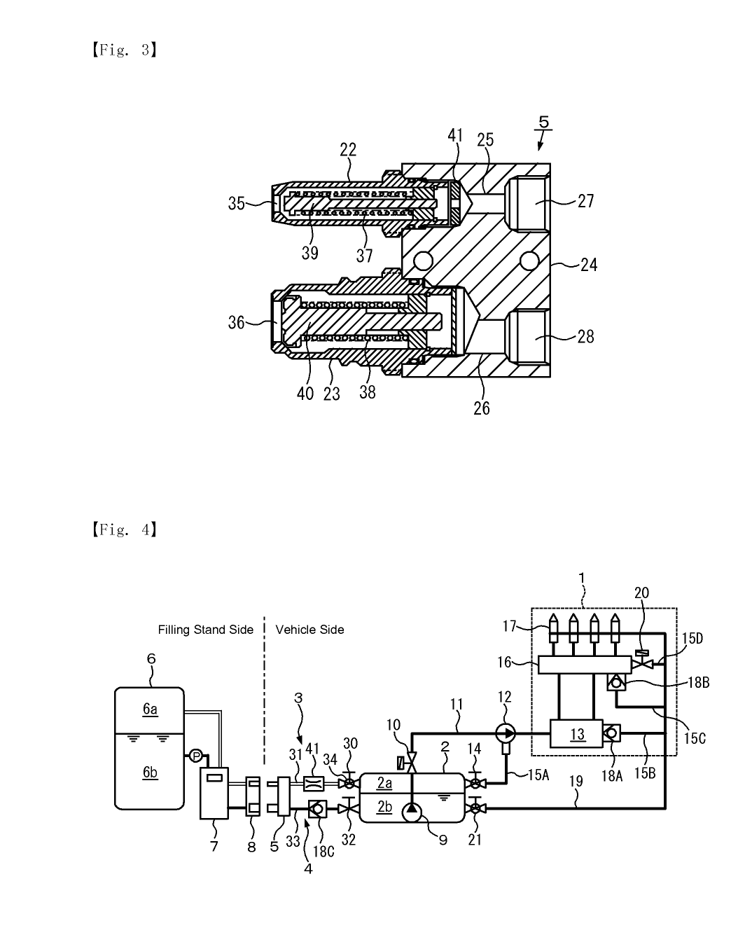

As illustrated in FIG. 3, the filling and pressure-balanced receptacle 5 is configured to be fixed to a housing 24 so that a pressure-balanced receptacle 22 and a filling receptacle 23 protrude in parallel in a connection direction. The pressure-balanced receptacle 22 and the filling receptacle 23 are connected to the pressure-balanced line 3 and the filling line 4 respectively via passages 25, 26 and connection openings 27, 28 formed in parallel to each other in the housing 24.

The pressure-balanced line 3 includes a pressure-balanced pipe 31 provided with a pressure-balanced valve 30 connected to the gas-phase region 2a of the fuel tank 2. Further, the filling line 4 includes a filling pipe 33 provided with the non-return valve 18C and a filling valve 32 connected to the liquid-phase region 2b of the fuel tank 2. Inside the pressure-balanced valve 30, an excess flow prevention valve 34 is provided to prevent the DME from abnormally flowing out when the pressure-balanced pipe 31 is ruptured.

Inside the pressure-balanced receptacle 22 and the filling receptacle 23, valve bodies 39, 40 are disposed that are always urged by springs 37, 38 in a direction for closing opening portions 35, 36 at each end. The filling and pressure-balanced receptacle 5 is combined with the filling and pressure-balanced nozzle 8, a pressure-balanced nozzle (not illustrated) at a facing filling and pressure-balanced nozzle 8 side presses the valve body 39 in the pressure-balanced receptacle 22, and a filling nozzle (not illustrated) presses the valve body 40 in the filling receptacle 23 against the elastic force of springs 37, 38 so that the opening portions 35, 36 of the pressure-balanced receptacle 22 and the filling receptacle 23 are opened to contact with the pressure-balanced line 3 and the filling line 4 respectively.

Behind the valve body 39 of the pressure-balanced receptacle 22 of the filling and pressure-balanced receptacle 5, an orifice 41 is provided. The orifice 41 is provided as described above to limit a flow amount of the gas flowing in the pressure-balanced line 3 even when the differential pressure between the gas-phase region 6a of the storage tank 6 and the gas-phase region 2a of the fuel tank 2 becomes larger when the outside air temperature becomes higher. Therefore, since the flow amount of the gas passing through the excess flow prevention valve 34 is decreased, the differential pressure becomes to be an action differential pressure or lower. Thus, the excess flow prevention valve 34 does not act, and the DME can be smoothly filled from the storage tank 6 into the fuel tank 2.

FIG. 4 illustrates the liquefied gas fuel filling system according to the second embodiment of the present invention. The same reference numeral is applied to the same component illustrated in FIG. 1, and the component will not be repeatedly described.

According to the second embodiment, the orifice 41 is not provided in the pressure-balanced receptacle 22 but in the pressure-balanced pipe 31 between the filling and pressure-balanced receptacle 5 and the pressure-balanced valve 30. With this arrangement, even when the differential pressure between the gas-phase region 6a of the storage tank 6 and the gas-phase region 2a of the fuel tank 2 becomes larger when the outside air temperature becomes higher, the flow amount of the gas flowing via a pressure-balanced line 3 is limited with the orifice 41 so that the excess flow prevention valve 34 does not act, and thus the DME can be smoothly filled from the storage tank 6 into the fuel tank 2.

However, not to disturb the action of the excess flow prevention valve 34 when the pressure-balanced pipe 31 is ruptured, it is preferable that the orifice 41 be provided close to the filling and pressure-balanced receptacle 5.

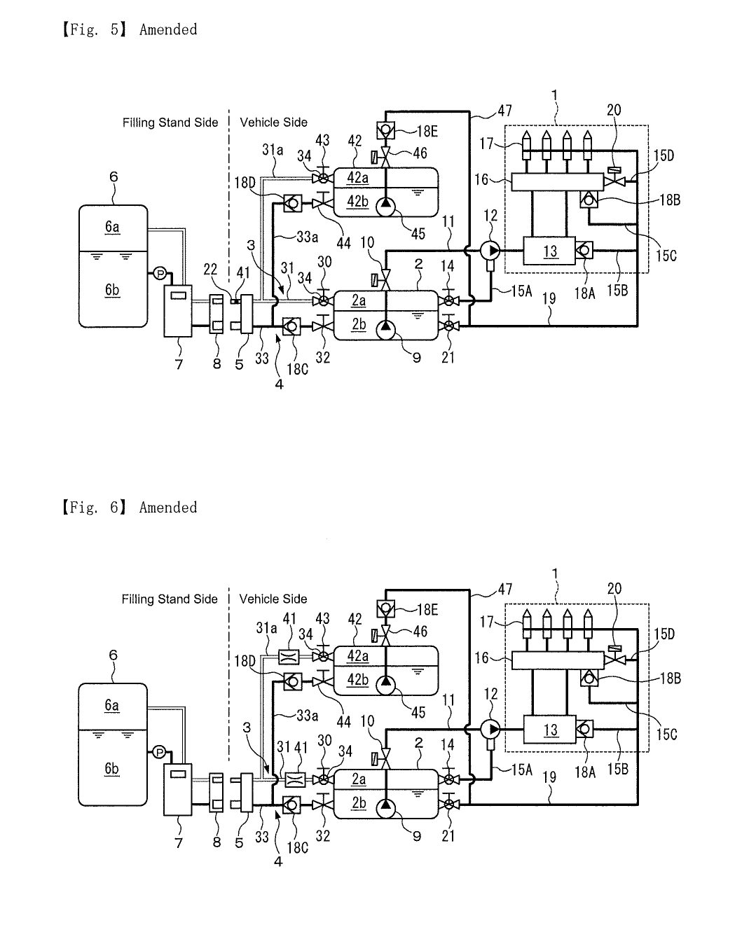

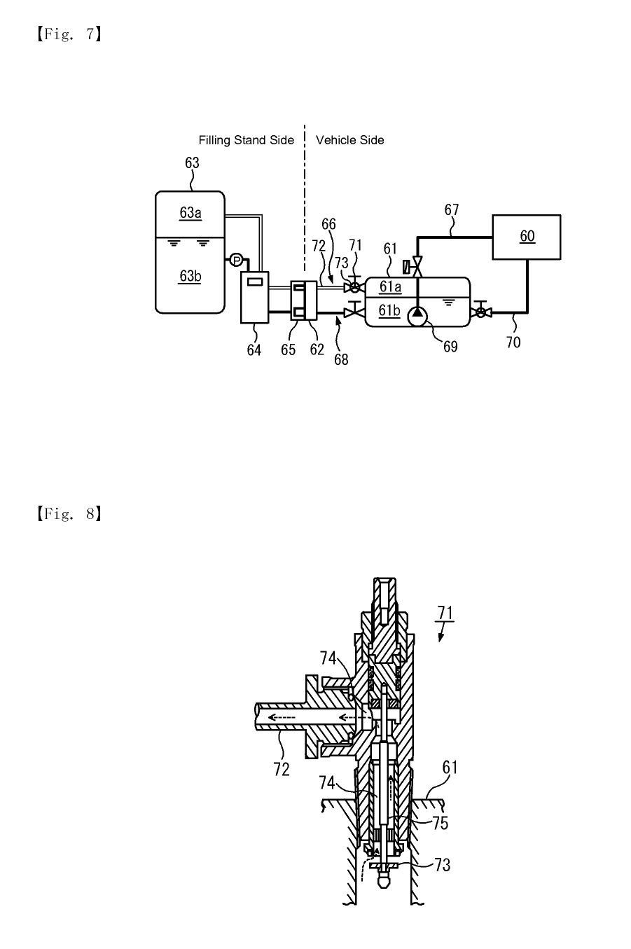

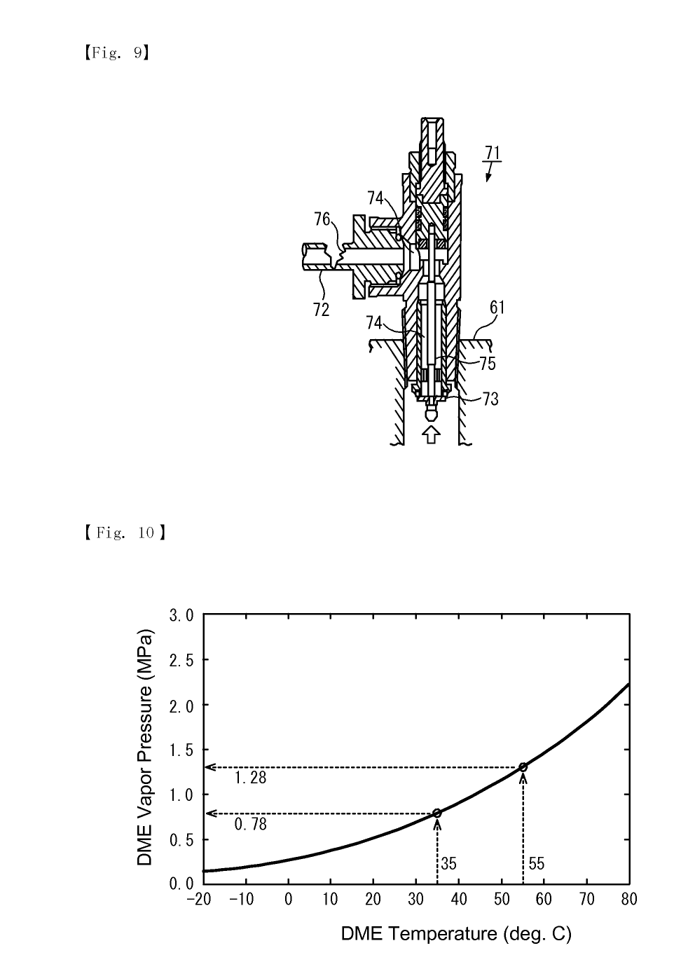

According to any of the embodiments described above, one fuel tank 2 is used, however, as illustrated in FIGS. 5, 6, a large vehicle is typically provided with a sub tank 42.

According to examples illustrated in FIGS. 5, 6, the pressure-balanced pipe 31 and the filling pipe 33 extended from the filling and pressure-balanced receptacle 5 are separated right before the fuel tank 2 and connected with the gas-phase region 42a and the liquid-phase region 42b of the sub tank 42 respectively. The separated pressure-balanced pipe 31a is provided with a second pressure-balanced valve 43 including the excess flow prevention valve 34. Further, the separated filling pipe 33a is provided with the check valve 18D and a second filling valve 44. The DME stored in the sub tank 42 is suctioned up into a supplementary pipe 47 via a electromagnetic valve 46 and the check valve 18E by a sub pressing and feed pump 45 provided in the tank, and transferred into the fuel tank 2 via the main return pipe 19.

In such a liquefied gas fuel filling system also, as illustrated in FIG. 5, the orifice 41 is provided in the pressure-balanced receptacle 22 of the filling and pressure-balanced receptacle 5, or as illustrated in FIG. 6, the orifice 41 is provided between the pressure-balanced valve 30 in the pressure-balanced pipe 31 and the filling and pressure-balanced receptacle 5, and between the second pressure-balanced valve 43 in the separated pressure-balanced pipe 31a and the filling and pressure-balanced receptacle 5, so that the DME can be smoothly filled from the storage tank 6 to the fuel tank 2 and the sub tank 42, even when the differential pressure between the gas-phase region 6a of the storage tank 6 and the gas-phase region 2a of the fuel tank 2 and between the gas-phase region 6a of the storage tank 6 and the gas-phase region 42a of the sub tank 42 becomes larger when the outside air temperature becomes higher.

According to the example illustrated in FIG. 6, not to prevent the action of the excess flow prevention valve 34 when the pressure-balanced pipe 31 and/or the separated pressure-balanced pipe 31a are/is ruptured, it is preferable that each orifice 41 be provided close to the filling and pressure-balanced receptacle 5.

According to the liquefied gas fuel filling system of the present invention, the DME is preferably used as the liquefied gas, however, the present invention is not limited thereto, and for example, LP gas and so on can be used.

### EXPLANATION OF REFERENCE NUMERALS

1 Diesel Engine

2 Fuel Tank

2a Gas-Phase Region (Of Fuel Tank)

2b Liquid-Phase Region (Of Fuel Tank)

3 Pressure-Balanced Line

4 Filling Line

5 Filling And Pressure-Balanced Receptacle

6 Storage Tank

6a Gas-Phase Region (Of Storage Tank)

6b Liquid-Phase Region (Of Storage Tank)

Filling And Pressure-Balanced Nozzle

Pressure-Balanced Receptacle

Filling Receptacle

30 Pressure-Balanced Valve

31 Pressure-Balanced Pipe

32 Filling Valve

34 Excess Flow Prevention Valve

41 Orifice

1. A liquefied gas fuel filling system for a vehicle comprising:
connector to connect with a gas-phase region and a liquid-phase region of a storage tank of liquefied gas;
a second connector removably connected to the first connector to connect with a gas-phase region and a liquid-phase region of a fuel tank of the vehicle;
an excess flow prevention valve provided at a pressure-balanced line for making the second connector and the gas-phase region of the fuel tank contact each other,
wherein the gas-phase regions of the storage tank and the fuel tank are connected with each other and the liquid-phase regions thereof are connected with each other so as to fill the liquefied gas from the storage tank into the fuel tank;
an orifice provided at a place where the orifice is connected with the pressure-balanced line of the second connector, or between the second connector and the excess flow prevention valve in the pressure-balanced line.

2. The liquefied gas fuel filling system according to claim 1, wherein the liquefied gas is DME.
